(19) United States
(12) Patent Application Publication
(10) Pub. No.: US 2025/0273790 A1
(43) Pub. Date: Aug. 28, 2025

(54) ELECTRICITY STORAGE DEVICE

(71) Applicant: TOYOTA JIDOSHA KABUSHIKI KAISHA, Aichi-ken (JP)

(72) Inventors: Kazuhito KATO, Toyota-shi (JP); Yoshiro OBAYASHI, Toyota-shi (JP); Yosuke SHIMURA, Nagakute-shi (JP); Kenta MIYAHARA, Toyohashi-shi (JP); Takuya NOGUCHI, Toyota-shi (JP); Masaya OGURA, Hamamatsu-shi (JP); Yuji KATAYAMA, Okazaki-shi (JP); Ryutaro SUZUKI, Hamamatsu-shi (JP)

(21) Appl. No.: 18/991,703

(22) Filed: Dec. 23, 2024

(30) Foreign Application Priority Data
Feb. 26, 2024 (JP) 2024-026637

(51) Int. Cl. H01M 50/242; H01M 50/209

(52) U.S. Cl. CPC H01M 50/242; H01M 50/209

(57) ABSTRACT

An electricity storage device (battery) includes a first cell string (cell string) and a second cell string (cell string). The first cell string and the second cell string each include a plurality of electricity storage cells that is arrayed in a coupling direction and connection parts that electrically connect the electricity storage cells to one another. The electricity storage device further includes wrapping members (members) that are inclined relative to the coupling direction at least at one part and that are wrapped around the electricity storage cells included in the first cell string and the electricity storage cells included in the second cell string.

### CROSS-REFERENCE TO RELATED APPLICATION

This application claims priority to Japanese Patent Application No. 2024-026637 filed on Feb. 26, 2024, incorporated herein by reference in its entirety.

### BACKGROUND

### 1. Technical Field

This disclosure relates to an electricity storage device including a plurality of cell strings.

### 2. Description of Related Art

Japanese Unexamined Patent Application Publication (Translation of PCT Application) No. 2023-502457 (JP 2023-502457 A) discloses a rectangular parallelepiped battery (electricity storage device) of which a length L is 400 mm to 2500 mm and a ratio of the length L to a width H (L/H) is 4 to 21.

### SUMMARY

In the electricity storage device described in JP 2023-502457 A, a plurality of electrode body sets (electricity storage cells) connected in series and arrayed in one row is disposed inside a housing. Hereinafter, a string of a plurality of electricity storage cells connected in one row will be referred to as a “cell string.”

To improve the volume energy density of an electricity storage device, housing a plurality of cell strings, rather than only one cell string, inside a case is more advantageous. However, if the cell strings move excessively inside the case, a connection part between these cell strings or a connection part between the electricity storage cells is likely to become damaged.

This disclosure has been made to solve the above-described problem, and an object thereof is to improve the impact resistance of an electricity storage device including a plurality of cell strings.

According to one form of this disclosure, an electricity storage device shown below is provided.

(First Item) The electricity storage device includes a first cell string and a second cell string. The first cell string and the second cell string each include a plurality of electricity storage cells that is arrayed in a coupling direction and connection parts that electrically connect the electricity storage cells to one another. The electricity storage device further includes wrapping members that are inclined relative to the coupling direction at least at one part and that are wrapped around the electricity storage cells included in the first cell string and the electricity storage cells included in the second cell string.

When the electricity storage cells of the first cell string and the electricity storage cells of the second cell string are provided with the wrapping members as described above, the impact resistance of the first cell string and the second cell string is likely to improve. When the wrapping members are wrapped around the electricity storage cells of the respective cell strings so as to be inclined relative to the coupling direction, the first cell string and the second cell string are likely to have high strength against both impact in the coupling direction and impact in a direction orthogonal to the coupling direction. The above-described configuration can improve the impact resistance of an electricity storage device including a plurality of cell strings. Note that the first cell string and the second cell string may be electrically connected to each other but do not have to be electrically connected to each other.

(Second Item) The electricity storage device according to the first item further includes a case that houses the first cell string and the second cell string. The case has a rectangular parallelepiped shape with a longitudinal direction oriented in the coupling direction.

When unified by the wrapping members, the first cell string and the second cell string are easy to insert into the rectangular parallelepiped case. The rectangular parallelepiped case has a simple shape and is therefore easy to manufacture. The above-described configuration can facilitate the manufacturing of the electricity storage device and helps reduce the manufacturing cost.

(Third Item) In the electricity storage device according to the first item or the second item, the case has four faces that extend in the coupling direction and two faces that cover end portions of each of the first cell string and the second cell string. The four faces include first opposite faces that are a pair of opposite faces and second opposite faces that are opposite faces with a larger area than the first opposite faces. The wrapping members are inclined relative to the coupling direction on the first opposite faces.

Inclining the wrapping members on the faces with a smaller area as described above can reduce the likelihood of the wrapping members becoming excessively twisted.

(Fourth Item) In the electricity storage device according to any one of the first item to the third item, the wrapping members have a band shape or a sheet shape and have an adhesive face on at least one side. The adhesive face includes an adhesive agent that dissolves in an organic solvent.

This configuration helps appropriately unify the electricity storage cells of the first cell string and the electricity storage cells of the second cell string using the adhesive faces of the wrapping members. As the adhesive agent in the adhesive faces dissolves in an organic solvent, the first cell string and the second cell string are easily decomposable, which increases the recyclability of the electricity storage device.

(Fifth Item) In the electricity storage device according to any one of the first item to the fourth item, the wrapping members are each wrapped so as to straddle at least either the connection part that is located between the adjacent electricity storage cells in the first cell string or the connection part that is located between the adjacent electricity storage cells in the second cell string.

This configuration helps effectively unify the electricity storage cells of the first cell string and the electricity storage cells of the second cell string using fewer wrapping members.

Note that, as another form, a vehicle including the electricity storage device according to any one of the first item to the fifth item may be provided.

This disclosure makes it possible to improve the impact resistance of an electricity storage device including a plurality of cell strings.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view for describing the configuration of an electricity storage device according to an embodiment of this disclosure;

FIG. 2 is a perspective view showing, in close-up, an inside of a case of the electricity storage device shown in FIG. 1;

FIG. 3 is a view for describing the configuration of each cell string shown in FIG. 1;

FIG. 4 is a sectional view along line IV-IV in FIG. 1;

FIG. 5 is a view showing first and second modified examples of the electricity storage device shown in FIG. 1; and

FIG. 6 is a view showing a third modified example of the electricity storage device shown in FIG. 1.

### DETAILED DESCRIPTION OF EMBODIMENTS

An embodiment of this disclosure will be described in detail with reference to the drawings. The same or equivalent parts in the drawings will be denoted by the same reference sign while description thereof will not be repeated. Of an X axis, a Y axis, and a Z axis that are orthogonal to one another in the drawings to be used below, the X axis indicates a first in-plane direction of a battery (e.g., a length direction); the Y axis indicates a second in-plane direction of the battery (e.g., a width direction); and the Z axis indicates a height direction of the battery. Hereinafter, the directions in which the arrows of the X axis, the Y axis, and the Z axis point will be denoted with a prefix of “+,” and the opposite directions will be denoted with a prefix of “−.”

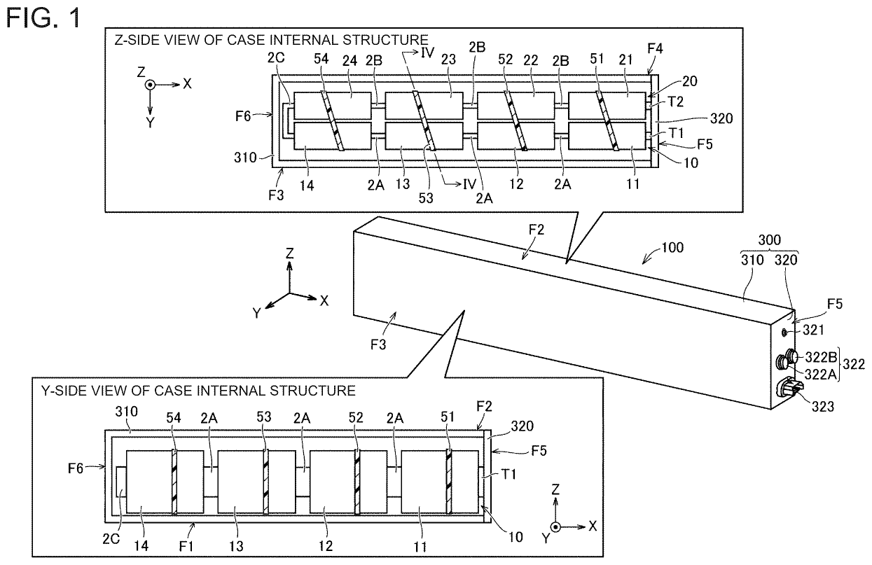

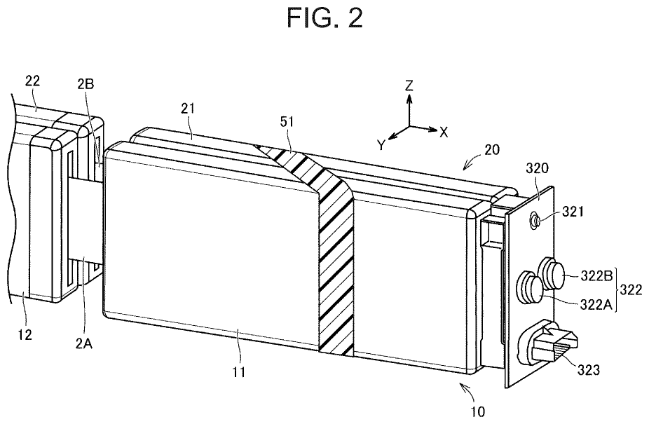

FIG. 1 is a view for describing the configuration of an electricity storage device according to this embodiment. “Z-SIDE VIEW OF CASE INTERNAL STRUCTURE” in FIG. 1 is a view of contents of a case as seen from the +Z side. “Y-SIDE VIEW OF CASE INTERNAL STRUCTURE” in FIG. 1 is a view of the contents of the case as seen from the +Y side. FIG. 2 is a perspective view showing, in close-up, an end portion on the +X side of the contents of the case.

The electricity storage device according to this embodiment is a battery 100 shown in FIG. 1. The battery 100 is, for example, a secondary battery such as a lithium-ion battery, a nickel-metal hydride battery, or a sodium ion battery. Examples of lithium ion batteries include an LFP battery that adopts lithium iron phosphate as a positive electrode active material, and a ternary battery that adopts nickel-manganese-cobalt (NMC) as a positive electrode active material. The type of the secondary battery may be a liquid-type secondary battery or may be an all-solid-state secondary battery. As will be described in detail later, the battery 100 includes a plurality of electricity storage cells each functioning as a secondary battery. The battery 100 may include only electricity storage cells of the same type (e.g., only LFP batteries) or may include electricity storage cells of different types (e.g., LFP batteries and ternary batteries).

The battery 100 includes a case 300. The case 300 has a rectangular parallelepiped external shape (rectangular parallelepiped shape) with a longitudinal direction oriented in the X direction. The case 300 has a pair of faces F1, F2 opposite each other in the Z direction (first opposite faces), a pair of faces F3, F4 opposite each other in the Y direction (second opposite faces), and faces F5, F6 located at ends in the X direction (end faces in the X direction). The area of each of the faces F1, F2 is smaller than the area of each of the faces F3, F4. The length (the dimension in the X direction) of the case 300 is longer than the width (the dimension in the Y direction) of the case 300. The length of the case 300 may be 250 mm or longer and 5000 mm or shorter, and is, for example, about 1000 mm. The width of the case 300 may be 10 mm or longer and 1250 mm or shorter, and is, for example, about 50 mm. The ratio of the length of the case 300 to the width of the case 300 may be 4 or higher and 25 or lower. The height (the dimension in the Z direction) of the case 300 may be 10 mm or longer and 1250 mm or shorter, and is, for example, about 100 mm. However, the dimensions of the case 300 are not limited to those mentioned above.

The case 300 includes a main body 310 and a lid body 320. The main body 310 is a housing having a tubular shape closed on one side and provided with an opening in an end face on the +X side, for example, and houses cell strings 10 and 20. The lid body 320 is a plate-shaped member (cover member) having an external shape corresponding to the opening of the main body 310, and closes the opening on the +X side of the main body 310. The main body 310 and the lid body 320 may be made of the same material or may be made of different materials. As the material composing each of the main body 310 and the lid body 320, for example, metal can be adopted. The case 300 may be an aluminum case. However, these materials can be changed as appropriate. For example, the lid body 320 may be made of an insulating material.

The cell string 10 (first cell string) includes four electricity storage cells 11 to 14 that are arrayed in the X direction and three connection parts 2A that electrically connect the electricity storage cells to one another. The electricity storage cells 11 to 14 are connected in one row in the X direction inside the case 300. The cell string 20 (second cell string) includes four electricity storage cells 21 to 24 that are arrayed in the X direction and three connection parts 2B that electrically connect the electricity storage cells to one another. The electricity storage cells 21 to 24 are connected in one row in the X direction inside the case 300. Thus, the cell string 10 and the cell string 20 are disposed parallel to each other in the X direction. Each of the faces F1 to F4 (four faces) of the case 300 extends in a coupling direction of the cell strings 10, 20 (X direction). Each of the faces F5, F6 of the case 300 covers end portions in the X direction of the cell strings 10, 20. Each electricity storage cell included in the cell strings 10 and 20 is configured to be able to store electricity.

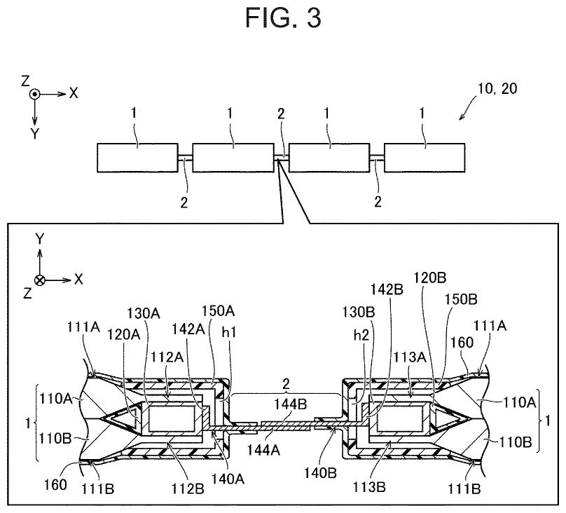

Inside the case 300 of the battery 100, the cell string 10 and the cell string 20 are electrically connected to each other. Specifically, as shown in FIG. 1, the end portion on the −X side (electricity storage cell 14) of the cell string 10 and the end portion on the −X-side (electricity storage cell 24) of the cell string 20 are electrically connected to each other inside the case 300 through a connection part 2C having, for example, a U-shape. The connection part 2C has basically the same structure as the connection part 2A or 2B except that the connection part 2C is formed in a different shape. (While the connection part 2C has a U-shaped cross-section, each of the connection parts 2A, 2B has an I-shaped cross-section.) The connection part 2C may be an integrally molded part or may be a composite body of a plurality of parts that has been separately molded. For example, the connection part 2C may be formed by connecting a protruding portion 144B (FIG. 3) that protrudes from the electricity storage cell 14 and a protruding portion 144B (FIG. 3) that protrudes from the electricity storage cell 24 to each other through an electrically conductive material (beam portion). Note that the protruding portions 144B will be described later.

The cell strings 10 and 20 are disposed such that the positions of the corresponding electricity storage cells and the corresponding connection parts are aligned. The electricity storage cells 11, 12, 13, 14 included in the cell string 10 respectively overlap the electricity storage cells 21, 22, 23, 24 included in the cell string 20 in the Y direction. Thus, all the electricity storage cells included in the cell string 10 are disposed so as to each face one of the electricity storage cells included in the cell string 20 in the Y direction. The end portion on the +X side (electricity storage cell 11) of the cell string 10 is connected to the lid body 320 through a connection terminal T1. The end portion on the +X side (electricity storage cell 21) of the cell string 20 is connected to the lid body 320 through a connection terminal T2.

The lid body 320 has a sealing hole 321, external terminals 322, and a connector 323. The sealing hole 321 may be a pressure adjustment hole for adjusting a pressure inside the case 300. The sealing hole 321 has, for example, a seal structure composed of a metal cap (outside the case) and a seal member (inside the case). This seal structure can secure airtightness inside the case 300, while allowing gas to be discharged to the outside of the case 300 through the sealing hole 321 when the pressure inside the case 300 exceeds a predetermined level. The external terminals 322 include an electrode tab 322A that is joined (e.g., by laser welding) to the connection terminal T1 (FIG. 1) of the cell string 10, and an electrode tab 322B that is joined (e.g., by laser welding) to the connection terminal T2 (FIG. 1) of the cell string 20. The electrode tabs 322A, 322B are electrically connected to the electricity storage cells 11, 21, respectively. Each of the electrode tabs 322A, 322B may have an insulating seal structure made of ceramic, for example, around the electrode. In this embodiment, the electrode tabs 322A, 322B function as a negative electrode tab and a positive electrode tab, respectively. However, without being limited thereto, the electrode tab 322B and the electrode tab 322A may be reversed in polarity and serve as a negative electrode tab and a positive electrode tab, respectively. The connector 323 includes, for example, an output terminal through which a detection signal showing a state inside the case 300 (e.g., a temperature of each electricity storage cell) detected by one or more sensors inside the case 300 is output to the outside of the case, and an input terminal through which a control signal is input from the outside of the case to one or more devices inside the case 300. For example, a temperature sensor may be provided for each electricity storage cell inside the case 300.

In the cell strings 10 and 20, as shown in FIG. 1 and FIG. 2, the electricity storage cells 11 and 21 are unified as a band-shaped member 51 is wrapped around them; the electricity storage cells 12 and 22 are unified as a band-shaped member 52 is wrapped around them; the electricity storage cells 13 and 23 are unified as a band-shaped member 53 is wrapped around them; and the electricity storage cells 14 and 24 are unified as a band-shaped member 54 is wrapped around them. Each of the members 51 to 54 is wrapped around the electricity storage cell of the cell string 10 and the electricity storage cell of the cell string 20 that are opposite each other in the Y direction, with an axis slightly inclined relative to the X direction as a rotational axis, to thereby unify these electricity storage cells. Each of the members 51 to 54 is inclined relative to the X direction (the coupling direction of the cell strings 10, 20) on each of a face on the −Z side (the side of the face F1) of each electricity storage cell and a face on the +Z side (the side of the face F2) of each electricity storage cell. The members 51 to 54 are wrapped in the same direction (wrapping direction). Each of the members 51 to 54 corresponds to one example of the “wrapping member” according to this disclosure.

The cell strings 10 and 20 are inserted into the main body 310 in a state of being wrapped with the members 51 to 54. When unified by the members 51 to 54, the cell strings 10 and 20 are easy to insert into the main body 310. The members 51 to 54 may be mounted before welding of the connection parts 2A, 2B (e.g., welding of the protruding portions 144A and 144B to be described later), or may be mounted after the welding. After the cell strings 10 and 20 in the state of being wrapped with the members 51 to 54 are inserted into the main body 310, the main body 310 and the lid body 320 are joined together. The main body 310 and the lid body 320 are welded together, for example, by laser.

Note that at least either a pressure adjustment hole or a gas discharge valve may be provided in an end face on the −X side of the main body 310. As in the end face on the +X side of the main body 310, an opening may be formed in the end face on the −X side of the main body 310 as well. A lid body that has been formed separately from the tubular main body 310 may be joined to that opening (e.g., by laser welding).

In this embodiment, the cell string 10 and the cell string 20 have basically the same configuration. Hereinafter, therefore, when no distinction is made among the electricity storage cells 11 to 14 and 21 to 24, these cells will be referred to as “electricity storage cells 1,” and when no distinction is made between the connection parts 2A and 2B, these connection parts will be referred to as “connection parts 2.”

FIG. 3 is a view for describing the configuration of each of the cell strings 10 and 20. As shown in FIG. 3, each cell string includes four electricity storage cells 1. The connection parts 2 are provided between the adjacent electricity storage cells 1, and the connection parts 2 electrically connect these electricity storage cells 1 to one another. Each cell string is formed as the electricity storage cells 1 and the connection parts 2 are alternately arrayed. In each of the cell strings 10, 20, the electricity storage cells 1 are connected to one another through the connection parts 2. The rigidity of the connection part 2 is lower than the rigidity of the electricity storage cell 1. The electricity storage cells 11 to 14 and 21 to 24 are formed by the same electricity storage cells 1. Forming the cell strings 10 and 20 using the common electricity storage cells 1 facilitates the manufacturing of the battery 100 and can reduce the manufacturing cost.

In this embodiment, the electricity storage cell 1 is a laminate cell having one or more rolls. In the laminate cell, the one or more rolls functioning as electrode bodies are covered by a laminate exterior. In FIG. 2, the electricity storage cells are shown with the laminate exteriors omitted. The roll has, for example, a structure in which a positive electrode sheet and a negative electrode sheet are rolled with a separator interposed therebetween. Each of the positive electrode sheet and the negative electrode sheet includes an electrode foil and an active material layer.

In the following, the structures of the electricity storage cell 1 and the connection part 2 will be described using the sectional view of FIG. 3 (an X-Y sectional view around the connection part 2). The electricity storage cell 1 includes two rolls 110A, 110B, spacers 120A, 120B, terminal members 130A, 130B, and covers 150A, 150B.

The rolls 110A, 110B respectively have coated portions 111A, 111B, electrode tabs 112A, 112B, and electrode tabs 113A, 113B. Each of the coated portions 111A, 111B is a region of the electrode foil in the positive electrode sheet or the negative electrode sheet where the active material layer is provided. Each of the electrode tabs 112A, 112B, 113A, 113B is a region of the positive electrode sheet or the negative electrode sheet where the electrode foil is exposed (an uncoated portion where the active material layer is not provided). The electrode tabs 112A, 112B are located at end portions on the +X side of the rolls 110A, 110B, respectively. The electrode tabs 113A, 113B are located on end portions on the −X side of the rolls 110A, 110B, respectively.

The electrode tab 112A and the electrode tab 112B are disposed so as to overlap in the Y direction, and the spacer 120A and the terminal member 130A are provided between the electrode tab 112A and the electrode tab 112B. The electrode tab 113A and the electrode tab 113B are disposed so as to overlap in the Y direction, and the spacer 120B and the terminal member 130B are provided between the electrode tab 113A and the electrode tab 113B.

Each of the spacers 120A, 120B includes an insulating material (e.g., synthetic resin) and has an insulating property. Each of the spacers 120A, 120B has a shape of which the dimension in the Y direction becomes larger with increasing distance from the coated portions 111A, 111B increases. The terminal member 130A is connected to an end face on the +X side of the spacer 120A. The terminal member 130B is connected to an end face on the −X side of the spacer 120B. Each of the terminal members 130A, 130B includes an electrically conductive material (e.g., metal such as aluminum or copper) and has electrical conductivity. The roll 110A and the roll 110B are joined together (e.g., by laser welding) through the terminal members 130A and 130B.

Each of current collector terminals 140A, 140B is a component constituting a part of the connection part 2. The current collector terminals 140A, 140B respectively have support portions 142A, 142B and the protruding portions 144A, 144B. One of the current collector terminals 140A and 140B functions as a positive-electrode current collector terminal while the other one functions as a negative-electrode current collector terminal. In one example, the positive-electrode current collector terminal is made of aluminum and the negative-electrode current collector terminal is made of copper.

Each of the current collector terminals 140A, 140B is formed in an L-shape, and may be formed as two plate members that have been separately molded are joined together, or may be molded in an integral state by bending process. The support portion 142A is joined (e.g., by laser welding) to an end face on the +X side of the terminal member 130A. The support portion 142B is joined (e.g., by laser welding) to an end face on the −X side of the terminal member 130B.

The cover 150A covers an end portion on the +X side (including the electrode tabs 112A and 112B) of the electricity storage cell 1. The cover 150A is provided with a through-hole h1 for the protruding portion 144A. The protruding portion 144A passes through the through-hole h1 and protrudes to the +X side of the electricity storage cell 1. The cover 150B covers an end portion on the −X side (including the electrode tabs 113A and 113B) of the electricity storage cell 1. The cover 150B is provided with a through-hole h2 for the protruding portion 144B. The protruding portion 144B passes through the through-hole h2 and protrudes to the −X side of the electricity storage cell 1.

At the connection part 2, the protruding portion 144A of one of the two adjacent electricity storage cells 1 is joined (e.g., by laser welding) to the protruding portion 144B of the other electricity storage cell 1. This welded portion may be protected by a tape or the like. On surfaces of the two rolls 110A and 110B, the laminate exterior 160 is provided. The laminate exterior 160 is a laminate film, for example, and is provided on a surface of the electricity storage cell 1.

Note that the above-described configuration is merely one example of the configuration of the electricity storage cell 1, and changes can be made thereto as appropriate. For example, the number of the rolls included in the electricity storage cell 1 is not limited to two, and may be one or three or more. As the electrode body, a stack (e.g., a stack in which a positive electrode sheet and a negative electrode sheet are stacked with a separator interposed therebetween) may be adopted instead of a roll.

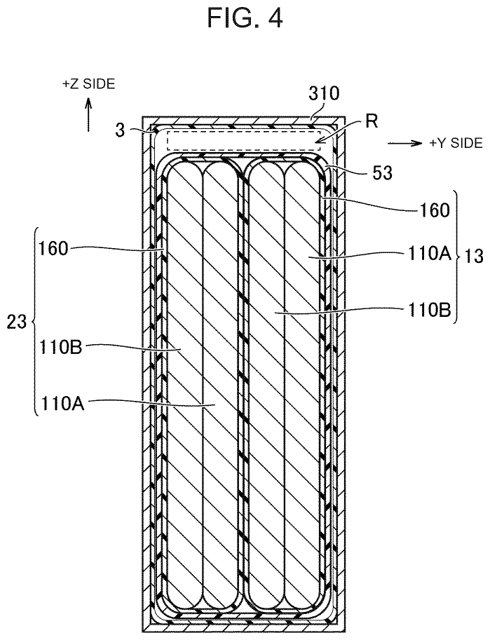

FIG. 4 is a sectional view along line IV-IV in FIG. 1. Line IV-IV lies along the wrapping direction of each of the members 51 to 54. The wrapping direction is inclined relative to the X direction in an X-Y plane. As shown in FIG. 4, the electricity storage cells 13 and 23 are unified as the member 53 is wrapped around them. While FIG. 4 shows only the member 53 provided on the pair of electricity storage cells 13 and 23 as a representative, the other pairs of electricity storage cells opposite each other in the Y direction (the pair of electricity storage cells 11, 21, the pair of electricity storage cells 12, 22, and the pair of electricity storage cells 14, 24) are similarly unified as the wrapping member (one of the members 51, 52, 54) is wrapped around them.

When the electricity storage cells of the cell string 10 and the electricity storage cells of the cell string 20 are unified as described above, the impact resistance of the cell strings 10 and 20 is likely to improve. As the wrapping members are wrapped around the electricity storage cells of the respective cell strings so as to be inclined relative to the coupling direction, the cell strings 10 and 20 are likely to have high strength against both impact in the coupling direction and impact in a direction orthogonal to the coupling direction. In addition, when the wrapping members are obliquely wrapped around the electricity storage cells of the cell string 10 and the electricity storage cells of the cell string 20, the rigidity of the cell strings 10 and 20 is likely to improve owing to the effect of the wrapping members being pliable. Thus, the above-described configuration can improve the impact resistance of an electricity storage device including a plurality of cell strings. Note that, while the electricity storage cell of the cell string 10 and the electricity storage cell of the cell string 20 next to each other in the Y direction are in contact with each other in the example shown in FIG. 4, these electricity storage cells may be disposed so as to be spaced apart.

On an inner surface of the main body 310 of the case 300, for example, an insulation layer 3 including resin, such as polyethylene terephthalate (PET), is provided. Thus, the case 300 and the parts inside the case 300 are electrically insulated from each other. However, the insulation layer 3 can be omitted in a battery in which sufficient insulation is secured. Each of the members 51 to 54 may be bonded to the inner surface of the case 300 by a bonding agent. There is a region R between a face on the +Z side of each electricity storage cell included in the cell strings 10 and 20 and the inner surface (ceiling surface) of the main body 310. In the region R, at least one of a heat management system (e.g., a heater and/or a temperature sensor), a gas discharge system (e.g., a gas flow passage and/or a pressure sensor), a flexible printed circuit board (FPC), and a wire leading to the connector 323 may be provided. A device and/or a sensor provided in the region R may be connected to the connector 323 of the lid body 320.

As shown in FIG. 1 and FIG. 2, in the battery 100, the wrapping members (members 51 to 54) are inclined relative to the coupling direction (X direction) on the first opposite faces (faces F1, F2: X-Y plane) having a smaller area than the second opposite faces (faces F3, F4: X-Z plane). Thus, the wrapping members are less likely to become excessively twisted. However, without being limited thereto, the wrapping members may be inclined on the second opposite faces instead of or in addition to the first opposite faces.

Each of the members 51 to 54 is a tape having adhesiveness, for example, on one side. Each of the members 51 to 54 is fixed to the corresponding electricity storage cells through the face having adhesiveness (adhesive face). This promotes the unification of the electricity storage cells of the cell string 10 and the electricity storage cells of the cell string 20. The adhesive face includes an adhesive agent (a substance that imparts adhesiveness to the adhesive face) that dissolves in an organic solvent. Thus, the cell strings 10 and 20 are easily decomposable, which increases the recyclability of the battery 100. In a form in which the battery 100 is a liquid-type battery, it is preferable that the members 51 to 54 be made of a material that has resistance to an electrolytic solution.

Each of the members 51 to 54 may be a tape having adhesiveness on both sides. In the case of such double-sided tapes, the cell strings 10 and 20 wrapped with the members 51 to 54 can be easily fixed to the case 300 without the need to separately provide a bonding agent. Further, a device and/or a sensor provided in the region R can be easily fixed by the adhesiveness of the double-sided tapes. In addition, the laminate exterior 160 can be easily peeled off by the double-sided tapes, which improves the recyclability of the battery 100.

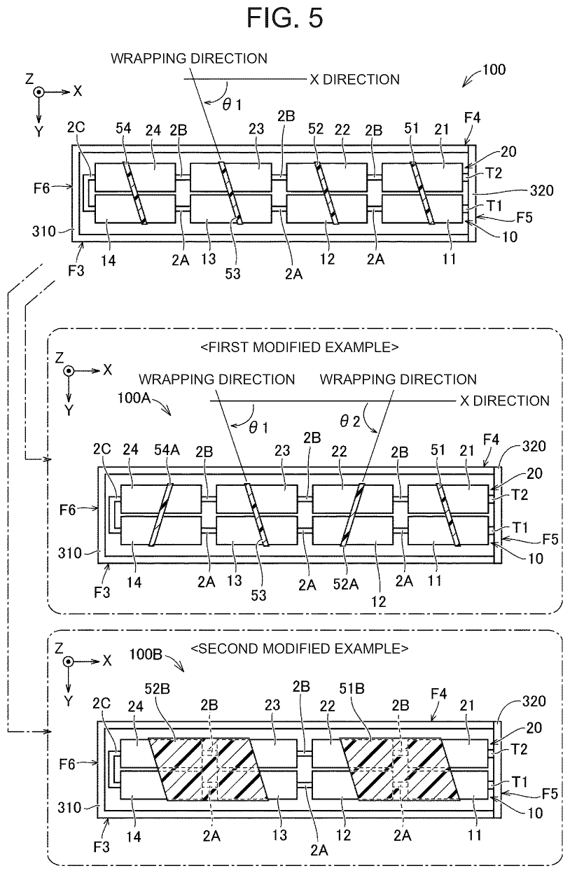

FIG. 5 is a view showing the battery 100 along with first and second modified examples of the battery 100. In the battery 100, an angle θ1 (more specifically, a minor angle) formed in an X-Y plane by the X direction (the coupling direction of the cell strings 10, 20) and the wrapping direction of each of the members 51 to 54 is smaller than 90°, and may be, for example, 25° or larger and 85° or smaller. To strengthen the unity between the electricity storage cells of the cell string 10 and the electricity storage cells of the cell string 20, it is preferable that the angle θ1 be set to 50° or larger and 85° or smaller. A groove in which the wrapping member (one of the members 51 to 54) enters (in other words, a groove that reduces the likelihood of displacement of the wrapping member) may be formed in a surface (at a wrapped portion) of each electricity storage cell to be wrapped with the wrapping member.

It is not essential that the wrapping directions of the respective members 51 to 54 match. The wrapping directions of the respective members 51 to 54 can be changed as appropriate. For example, the battery 100 may be modified like a battery 100A shown in FIG. 5. The battery 100A according to the first modified example has basically the same configuration as the battery 100. However, the battery 100A has a member 52A instead of the member 52 and a member 54A instead of the member 54. The members 52A, 54A are wrapped in different directions from the members 52, 54, respectively. In the battery 100A, in the X-Y plane shown in FIG. 5, a minor angle (angle θ1) between the X direction (coupling direction) and the wrapping direction of each of the members 51, 53 is formed on the +X side, while a minor angle (angle θ2) between the X direction (coupling direction) and the wrapping direction of each of the members 52A, 54A is formed on the −X side. Each of the members 52A, 54A is wrapped so as to be inclined in the opposite direction from the members 51, 53 with respect to a Y-Z plane (a plane orthogonal to the X direction). The magnitude of the angle θ2 may be the same as the angle θ1 or may be different from the angle θ1.

In each of the batteries 100, 100A, the wrapping members are band-shaped members. However, without being limited thereto, the wrapping members may be linear or sheet-shaped members. The wrapping members are not limited to tapes. For example, resin members, heat-shrinkable members, and elastic bodies (e.g., rubber bands), etc. can also be adopted as the wrapping members. The battery 100 may be modified like a battery 100B shown in FIG. 5.

The battery 100B according to the second modified example has basically the same configuration as the battery 100. However, the battery 100B includes a member 51B instead of the members 51 and 52 and a member 52B instead of the members 53 and 54. The member 51B is wrapped so as to straddle the connection part 2A located between the adjacent electricity storage cells 11 and 12 in the cell string 10 and the connection part 2B located between the adjacent electricity storage cells 21 and 22 in the cell string 20. The member 52B is wrapped so as to straddle the connection part 2A located between the adjacent electricity storage cells 13 and 14 in the cell string 10 and the connection part 2B located between the adjacent electricity storage cells 23 and 24 in the cell string 20. This configuration helps effectively unify each electricity storage cell included in the cell strings 10 and 20 using fewer wrapping members.

Each of the members 51B, 52B may be a resin film (e.g., a film including vinyl chloride resin, polyvinylidene chloride, polyethylene, or polyolefin). Each of the members 51B, 52B may be a heat-shrinkable sheet.

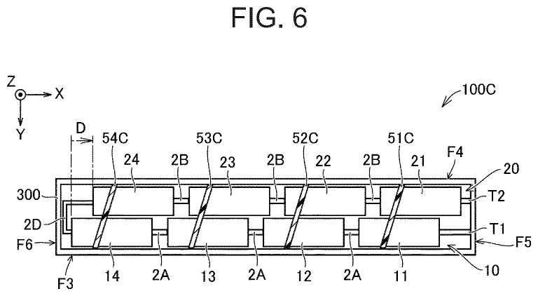

FIG. 6 is a view showing a third modified example of the battery 100. As shown in FIG. 6, in a battery 100C according to the third modified example, the cell string 20 is disposed so as to be offset relative to the cell string 10 toward the +X side by an offset amount D. Thus, all the connection parts 2A included in the cell string 10 each overlap one of the electricity storage cells 21 to 24 of the cell string 20 in the Y direction, and all the connection parts 2B included in the cell string 20 each overlap one of the electricity storage cells 11 to 14 of the cell string 10 in the Y direction. This configuration improves the impact resistance of the battery 100C as each connection part is reinforced by the electricity storage cell.

The cell strings 10 and 20 are electrically connected to each other through a connection part 2D. The connection part 2D includes a beam portion that is formed in a plate shape in a Y-Z plane, and a first leg portion and a second leg portion that are formed in a plate shape in an X-Z plane. The first leg portion is connected to the end portion on the −X side (electricity storage cell 14) of the cell string 10. The second leg portion is connected to the end portion on the −X side (electricity storage cell 24) of the cell string 20. The beam portion is a portion that connects the first leg portion and the second leg portion to each other. The connection part 2D is formed in a U-shape, and has basically the same structure as the connection part 2C (FIG. 1). In the connection part 2D, however, the length of the second leg portion in the X direction is longer than the length of the first leg portion in the X direction by the offset amount D.

The battery 100C includes members 51C to 54C instead of the members 51 to 54. Each of the members 51C to 54C is wrapped around the electricity storage cell of the cell string 10 and the electricity storage cell of the cell string 20 that are opposite each other in the Y direction, and is inclined in an X-Y plane relative to the X direction (the coupling direction of the cell strings 10, 20). Thus, the pair of electricity storage cells 11, 21, the pair of electricity storage cells 12, 22, the pair of electricity storage cells 13, 23, and the pair of electricity storage cells 14, 24 are each unified. Each of the members 51C to 54C has an inclination angle according to a positional relationship (offset) between the electricity storage cell of the cell string 10 and the electricity storage cell of the cell string 20. The wrapping direction of each of the members 51C to 54C is determined according to, for example, the offset amount D. This helps appropriately unify the cell strings 10 and 20. As the cell strings 10 and 20 are unified in this way, the impact resistance of the battery 100C improves.

The above-described batteries 100 and 100A to 100C can also independently function as an electricity storage device. However, a plurality of such batteries may be combined into a module. The batteries 100 and 100A to 100C can be installed, for example, in mobile bodies. Examples of mobile bodies include automobiles (battery electric vehicles, hybrid electric vehicles, etc.), vehicles other than automobiles (ships, airplanes, etc.), mobile machines (agricultural machines, construction machines, etc.), and unmanned mobile bodies (unmanned transport vehicles, robots, etc.). However, the purpose of the electricity storage device is arbitrary and may be a stationary purpose.

The number of the cell strings housed in the case 300 is not limited to two and may be three or more. Three or more cell strings may be unified by wrapping members.

The configuration of each cell string is not limited to the configuration shown in FIG. 3. Each cell string may include electricity storage cells of different dimensions, or may include electricity storage cells of different shapes. The number of the electricity storage cells housed in the case 300 is not limited to eight, either, and can be changed as appropriate. The number of the electricity storage cells included in each cell string may be smaller than four. For example, in the battery 100B shown in FIG. 5, the cell string 20 may be composed of two electricity storage cells and one connection part. For example, the electricity storage cells 21 and 22 may be combined to form a large electricity storage cell, and the electricity storage cells 23 and 24 may be combined to form a large electricity storage cell. In such a modified example, each of the members 51B, 52B is wrapped so as to straddle only the connection part 2A of the cell string 10, without straddling the connection part 2B of the cell string 20. The number of the electricity storage cells included in each cell string may be five or larger and 19 or smaller or may be 20 or larger.

The various characteristics relating to the above-described electricity storage device (the characteristics described in the embodiment and the modified examples) may be implemented in arbitrary combinations. The electricity storage device may be applied to a device other than a vehicle.

The embodiment disclosed this time should be construed as being in every respect illustrative and not restrictive. The scope of the present disclosure is indicated not by the description of the embodiment given above but by the claims, and is intended to include all changes within the meaning and scope of the claims and equivalents thereof.

What is claimed is:

1. An electricity storage device comprising a first cell string and a second cell string, wherein:
the first cell string and the second cell string each include a plurality of electricity storage cells that is arrayed in a coupling direction and connection parts that electrically connect the electricity storage cells to one another; and
the electricity storage device further comprises wrapping members that are inclined relative to the coupling direction at least at one part and that are wrapped around the electricity storage cells included in the first cell string and the electricity storage cells included in the second cell string.

2. The electricity storage device according to claim 1, wherein:
the electricity storage device further comprises a case that houses the first cell string and the second cell string; and
the case has a rectangular parallelepiped shape with a longitudinal direction oriented in the coupling direction.

3. The electricity storage device according to claim 2, wherein:
the case has four faces that extend in the coupling direction and two faces that cover end portions of each of the first cell string and the second cell string;
the four faces include first opposite faces that are a pair of opposite faces and second opposite faces that are opposite faces with a larger area than the first opposite faces; and
the wrapping members are inclined relative to the coupling direction on the first opposite faces.

4. The electricity storage device according to claim 1, wherein the wrapping members have a band shape or a sheet shape and have an adhesive face on at least one side, and the adhesive face includes an adhesive agent that dissolves in an organic solvent.

5. The electricity storage device according to claim 1, wherein the wrapping members are each wrapped so as to straddle at least either the connection part that is located between the adjacent electricity storage cells in the first cell string or the connection part that is located between the adjacent electricity storage cells in the second cell string.
